(19) United States
(12) Patent Application Publication
(10) Pub. No.: US 2026/0169504 A1
(43) Pub. Date: Jun. 18, 2026

(54) CORRECTION DEVICE

(71) Applicant: NTT DOCOMO, INC., Tokyo (JP)

(72) Inventors: Masaki MORISHITA, Tokyo (JP); Hiroki ISHIZUKA, Tokyo (JP); Masashi ANZAWA, Tokyo (JP); Keisuke NAKASHIMA, Tokyo (JP)

(21) Appl. No.: 19/109,773

(22) PCT Filed: Jul. 31, 2023
(86) PCT No.: PCT/JP2023/027950

§ 371 Date: Mar. 7, 2025

(30) Foreign Application Priority Data
Sep. 12, 2022 (JP) 2022-144799

(51) Int. Cl. G05D 1/86; B64U 10/13; G05D 1/48; G05D 1/69; G05D 109/25

(52) U.S. Cl. CPC G05D 1/86; G05D 1/69; B64U 10/13; B64U 2201/102; G05D 1/48; G05D 2109/254

(57) ABSTRACT

Operation control unit controls flight driving mechanism such that drone performs an operation by which detection values of sensors included in sensors included in drone match a target value. Detection unit detects, when a plurality of drones perform an operation by which detection values of the sensors included in sensors included in the plurality of drones match a target value, a difference in an operation result of each of drones. Clustering unit classifies a plurality of drones, including drone in which clustering unit is included, into at least one cluster based on differences in operation results detected by detection unit. Correction unit corrects the detection values of the sensors based on the operation results of drones included in a maximum cluster of the classified clusters.

### TECHNICAL FIELD

The present invention relates to a technique for reducing errors of sensors included in aerial vehicles.

### BACKGROUND

Unmanned aerial vehicles, referred to as drones use various sensors, such as cameras, radar, sonar, and GPS systems to control various flight operations. Japanese Patent No. 6080189 discloses a mechanism for obtaining and calibrating data from sensors included in an unmanned aerial vehicle.

### SUMMARY OF INVENTION

### Technical Problem

Significant time and cost are required to accurately calibrate multiple sensors included in each of a plurality of aerial vehicles. An object of the present invention is to reduce errors of sensors included in each of a plurality of aerial vehicles by implementation of a simple method.

### Solution to Problem

The present invention provides a correction device including: a detection unit configured to detect, when a plurality of aerial vehicles performs an operation by which detection values of sensors included therein match a target value, a difference in an operation result for each of the aerial vehicles; a clustering unit configured to classify the plurality of aerial vehicles into at least one cluster based on the detected differences; and a correction unit configured to correct the detection values of the sensors based on the operation results of the aerial vehicles included in a maximum cluster of the classified clusters.

According to the present invention, it is possible to reduce errors of sensors included in each of a plurality of aerial vehicles by implementation of a simple method.

### BRIEF DESCRIPTION OF DRAWINGS

FIG. 1 is a block diagram showing an example of a hardware configuration of drone 10 according to an embodiment of the present invention.

FIG. 2 is a block diagram showing an example of a functional configuration of drone 10.

FIG. 3 is a diagram illustrating differences in operation results of drones 10 relative to altitude.

FIG. 4 is a diagram illustrating a result of clustering a plurality of drones 10.

FIG. 5 is a diagram illustrating a result of correcting altitude sensors of drones 10.

FIG. 6 is a flowchart illustrating processing for correcting sensors in a plurality of drones 10.

### DETAILED DESCRIPTION

### Configuration

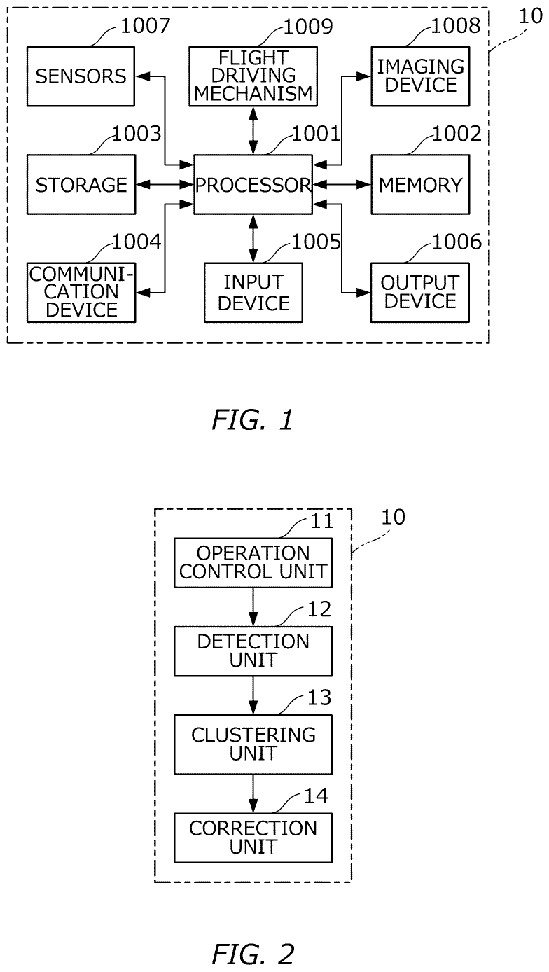

FIG. 1 is a diagram showing an example of the hardware configuration of a drone 10. Drone 10 is an unmanned aerial flight vehicle. Drone 10 is configured as a computer device, and includes a processor 1001, a memory 1002, a storage 1003, a communication device 1004, an input device 1005, an output device 1006, sensors 1007, an imaging device 1008, a flight driving mechanism 1009, and buses that connect these devices and the like. In the following description, instead of the term “device,” terms such as circuit, unit, or the like may be used. The hardware configuration of drone 10 may be configured to include one or a plurality of each of the devices, or may be configured to exclude some of the devices.

Each of the functions in drone 10 is realized by processor 1001 performing an operation that causes hardware such as processor 1001 or memory 1002 to read predetermined software (program), control communication by communication device 1004, control at least one of reading and writing of data from or to memory 1002 and storage 1003, and control sensors 1007, imaging device 1008, and flight driving mechanism 1009.

Processor 1001 performs overall control of the computer by running an operating system, for example. Processor 1001 may be configured as a central processing unit (CPU) that has interfaces for peripheral devices, a control device, an operation device, a register, and the like. For example, a baseband signal processing unit, a call processing unit, or the like may be realized by processor 1001.

Processor 1001 reads out a program (program code), a software module, data, and the like from at least one of storage 1003 and communication device 1004 to memory 1002, and executes various types of processing accordingly. The program used causes the computer to execute at least some of the following operations. The functional block of drone 10 may be realized by a control program stored in memory 1002 and operated in processor 1001. Various types of processing may be executed by one processor 1001, or may be executed simultaneously or consecutively by two or more processors 1001. Processor 1001 may be implemented by one or more chips. It is of note that the program may be transmitted to drone 10 via wireless communication network 40.

Memory 1002 is a computer-readable recording medium, and may be configured to have, for example, at least one of a ROM, an erasable programmable ROM (EPROM), an electrically erasable programmable ROM (EEPROM), a RAM, and the like. Memory 1002 may be referred to as a register, a cache, a main memory (main storage device), or the like. Memory 1002 is capable of storing a program (program code), a software module, or the like that can be executed to implement the method according to the present embodiment.

Storage 1003 is a computer-readable recording medium, and may be configured by, for example, at least one of an optical disk such as a compact disc ROM (CD-ROM), a hard disk drive, a flexible disk, a magneto-optical disk (e.g., a compact disk, a digital versatile disk, a Blu-ray (registered trademark) disk, a smart card, a flash memory (e.g., a card, a stick, a key drive), a Floppy (registered trademark) disk, a magnetic strip, and the like. Storage 1003 may be referred to as an auxiliary storage device. Storage 1003 stores various programs and data groups.

Processor 1001, memory 1002, and storage 1003 described above function as a control device that controls flight of drone 10, and also function as a correction device according to the present invention.

Communication device 1004 includes hardware (a transmitting/receiving device) for performing communication between computers via a wireless communication network (not shown), and a hardware (transmitting/receiving device) for performing wireless communication between drones 10. Communication device 1004 is also referred to, for example, as a network device, a network controller, a network card, a communication module, and the like. In order to realize frequency division duplexing and time-division duplexing, communication device 1004 includes a high-frequency switch, a duplexer, a filter, a frequency synthesizer, and the like. A transmission/reception antenna, an amplifier unit, a transmission/reception unit, a transmission line interface, and the like may be realized by communication device 1004. The transmission/reception unit may be implemented by a transmission unit and a reception unit that are physically or logically separated.

Input device 1005 is an input device that receives input from the outside, and includes, for example, a key, a switch, a microphone, or the like. Output device 1006 is an output device that performs output to the outside, and includes, for example, a display device such as a liquid crystal display, a speaker, or the like. It is of note that input device 1005 and output device 1006 may be integrated.

Sensors 1007 includes, for example, range sensors, altitude sensors, gyrosensors, speed sensors, acceleration sensors, direction sensors, GPS (Global Positioning System) devices or the like. These devices are used for controlling flight of drones 10.

Imaging device 1008 is a device for obtaining, when plurality of drones 10 perform an operation by which detection values of sensors included in each of the plurality of drones 10 match a target value, images for detecting a difference in an operation result of each of drones 10.

Flight driving mechanism 1009 is a mechanism that enables each drone 10 to fly, and includes, for example, hardware such as a motor, a shaft, a gear, and a propeller.

The devices such as processor 1001 and memory 1002 are connected by a bus for communicating information. The bus may be configured as a single bus, or may be configured as more than one bus that differs for connection between devices. Drone 10 may include hardware such as a microprocessor, a digital signal processor (DSP), an application specific integrated circuit (ASIC), a programmable logic device (PLD), and a field programmable gate array (FPGA), and a part or the whole of each functional block may be realized by the aforementioned hardware. For example, processor 1001 may be implemented with at least one of the aforementioned pieces of hardware.

FIG. 2 is a diagram showing an example of the functional configuration of drone 10. In drone 10, the functions of operation control unit 11, detection unit 12, clustering unit 13, and correction unit 14 are realized by cooperation of the above-described hardware. Operation control unit 11, detection unit 12, clustering unit 13, and correction unit 14 comprise the correction device according to the present invention.

Operation control unit 11 controls flight driving mechanism 1009 such that drone 10 performs an operation by which detection values of the sensors included in sensors 1007 included in drone 10 match a target value. Here, an operation by which detection values of the sensors match a target value is, for example, an operation by which drone 10 hovers while maintaining a position at which detection values of altitude sensors included in sensors 1007 have an altitude of 10 m (target value).

When a plurality of drones 10 performs an operation by which detection values of the sensors included in sensors 1007 included in the plurality of drones 10 match a target value, the detection unit 12 detects a difference in an operation result of each of drones 10.

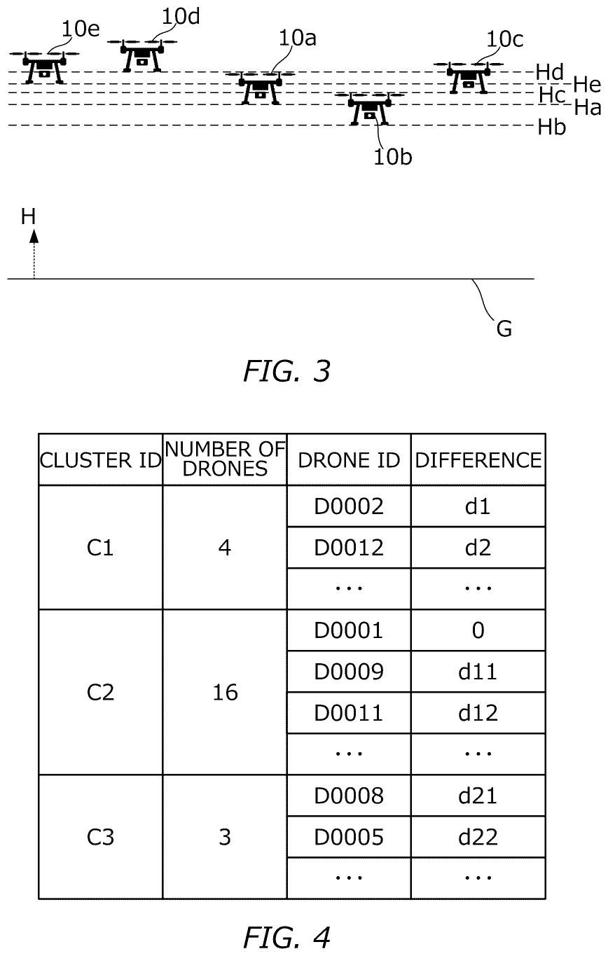

FIG. 3 is a diagram illustrating differences in operation results of drones 10 in relation to altitude. The actual altitudes of drones 10a to 10e are illustrated when drones 10a to 10e perform an operation whereby detection values of sensors 1007 (altitude sensors) included in each of drones 10a to 10e match a target value (e. g., a distance of 10 m from ground G in a vertically upward direction H). As illustrated in FIG. 3, although detection values of each of altitude sensors of each of drones 10a to 10e show that the altitude of each of the drones 10a to 10e match an altitude of 10 m, the actual altitudes of drones 10a to 10e differ from each other due to errors of the altitude sensors. Specifically, drone 10a has an altitude of Ha, drone 10b has an altitude of Hb, drone 10c has an altitude of Hc, drone 10d has an altitude of Hd, and drone 10e has an altitude of He.

One (here drone 10a) of drones 10a to 10e detects differences in operation results of the other drones 10b to 10e, using its own altitude as a reference. Specifically, drones 10b to 10e each calculate their difference in altitude relative to drone 10a, by imaging drone 10a with imaging device 1008, and performing image processing based on a predetermined coordinate axis set for an imaging range. Then, via wireless communication, each of drones 10b to 10e notifies drone 10a of its detected difference in altitude between itself and drone 10a. Drone 10a detects differences in operation results based on its altitude by obtaining the altitude differences notified from each of drones 10b to 10e. As a result of each of drones 10b to 10e also performing the aforementioned processing, each of drones 10b to 10e detects differences in operation results using its own altitude as a reference.

Referring again to FIG. 2, clustering unit 13 classifies, based on the differences in operation results detected by detection unit 12, the plurality of drones 10, including drone 10 in which clustering unit 13 is included, into (one or more) clusters. The clustering method used here may be any method as long as it groups data into groups based on similarities. It is of note, however, that the plurality of drones 10 may include a drone whose sensors 1007 has been calibrated by a manager within a prior predetermined period. Such calibration involves correcting an accuracy of or error of a sensor by comparison with a predetermined standard. Such an operation requires a significant amount of time and cost. In a case that the plurality of drones 10 are an x number of drones, when the ratio of drones 10 of the x number of drones 10 that satisfy a predetermined calibration condition, such as having been calibrated within a prior predetermined period, for the sensors is r (0<r<1), it is preferable that clustering unit 13 performs clustering such that a maximum cluster in which the number of drones 10 included in each cluster is maximum includes a number of drones 10 that is greater than or equal to x×r. Sensors of drone 10 that have been calibrated within the prior predetermined period are expected to have detection values that are close to each other, and therefore it can be expected that there will be a relatively high possibility that a maximum cluster including a number of drones 10 that is greater than or equal to x×r will include drone 10 that has been calibrated within the prior predetermined period.

FIG. 4 is a diagram illustrating a result of clustering a plurality of drones 10. In the example shown in the drawing, the number of drones 10 included in each of three clusters having cluster IDs C1, C2, and C3, a drone ID, which is identification information of each drone 10, and a difference in an operation result of each drone 10 are associated with each other. It is of note that in the example shown in the drawing, a result of drone 10 having a drone ID of D001 performing clustering based on a difference in an operation result is illustrated. Accordingly, the difference corresponding to drone 10 is “0.”

Referring again to FIG. 2, correction unit 14 corrects detection values of the sensors based on operation results of drones 10 included in the maximum cluster of the classified clusters. Specifically, correction unit 14 determines a correction value by statistically processing operation results of drones 10 included in the maximum cluster. The phrase “statistical processing of operation results” as used herein refers to obtaining an average value, a median value, a mode, or the like of the operation results. For example, in the case of correcting altitude sensors, an average value, a median value, or a mode of the altitudes included in an altitude map of drones 10 included in the maximum cluster is obtained. As described above, the sensors of drone 10 that have been calibrated within the prior predetermined period are expected to have detection values that are close to each other. Therefore, there is a relatively high possibility that a maximum cluster including a number of drones 10 that is greater than or equal to x×r includes drone 10 that has been calibrated within the prior predetermined period. Accordingly, a value obtained by statistical processing of operation results of drones 10 included in the maximum cluster is a value that has a small error and a relatively high accuracy.

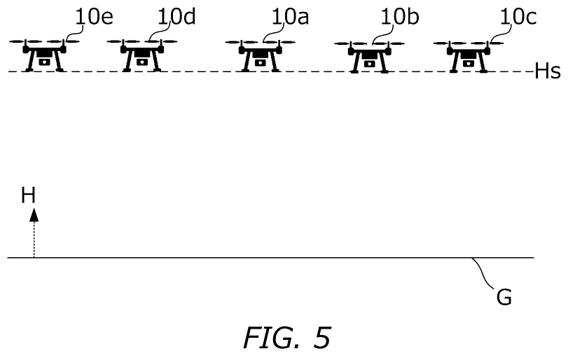

Correction unit 14 corrects the detection values of sensors included in the drone (drone 10a), using, as a correction value, a difference between a value obtained by statistical processing and the altitude of the drone in an altitude map. As a result of each of drones 10b to 10e performing the foregoing processing, the detection values of the sensors of each of drones 10b to 10e are also corrected. As a result, as illustrated in FIG. 5, the altitudes of drones 10 substantially match at an altitude of Hs.

### Operation

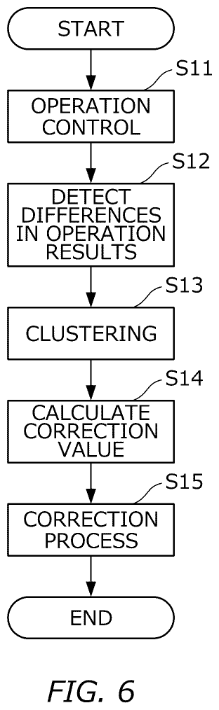

Next, an operation performed by drone 10a in the example shown in FIG. 4 will be described with reference to FIG. 6. First, operation control units 11 of drones 10a to 10e control flight-driving mechanism 1009 such that drones 10a to 10e perform an operation by which detection values of the sensors included in sensors 1007 included in drones 10a to 10e match a target value (step S11).

Detection unit 12 of drone 10a detects, when drones 10a to 10e perform an operation by which detection values of the sensors included in sensors 1007 included in each of drones 10a to 10e match a target value, a difference in an operation result of each of drones 10a to 10e (step S12).

Clustering unit 13 of drone 10a classifies drones 10a to 10e into (one or more) clusters based on differences in operation results detected by detection unit 12 (step S13).

Correction unit 14 determines a correction value based on operation results of drones 10 included in a maximum cluster of the classified clusters (step S14). Then, correction unit 14 corrects the detection values of the sensors of drone 10a, using, as the correction value, a difference between a value obtained by statistical processing and the altitude of drone 10a in an altitude map (step S15).

According to the above-described embodiment, there is no need to periodically calibrate individual drones 10, and errors of sensors included in each of the plurality of drones 10 can be reduced by implementation of a simple method. As a result, costs for maintaining drones is reduced while safety is improved.

### Modified Examples

The present invention is not limited to the above-described embodiment. The above-described embodiment may be modified as follows. Further, two or more of the following modified examples may be combined.

### Modified Example 1

In the embodiment, description is given of correction of attitude sensors. However, any sensors in drones 10 for which differences in operation results are detectable can be corrected. For example, in a case of correcting acceleration sensors, drones 10 are moved in a vertically upward direction for a few seconds at a predetermined acceleration of 0.1 m/s2, for example, and their relative positions are detected from a captured image, and the acceleration sensors are corrected based on differences in respective acceleration rates. In a case of correcting direction sensors, drones 10 hover with their noses oriented in a predetermined direction such as east, and their respective nose directions are detected from a captured image. Based on the differences in the respective nose directions, the direction sensors can be corrected.

It is of note that detection of differences is not limited to use of the imaging device illustrated in the embodiment, and it is possible to use, for example, a wireless infrastructure (e.g., LPWA: Low Power Wide Area-network) to measure positions.

### Modified Example 2

If ratio r of drones 10 that satisfy the predetermined calibration condition for the sensors is extremely small, a sufficient cluster size may not be achieved when the number of drones included in the maximum cluster is x×r. Therefore, if r is less than or equal to a predetermined threshold, clustering unit 13 may perform clustering such that the maximum cluster includes a number of drones that is greater than or equal to x×r+a (a is a positive constant). In this way the cluster size of the maximum cluster is optimized so that accurate correction of the sensor can be performed.

### Modified Example 3

On the other hand, if ratio r of drones 10 that satisfy the predetermined calibration condition for the sensors is extremely large, a processing time required to correct the sensors may excessively increase when the number of the drones included in the maximum cluster is x×r. Therefore, if x is greater than or equal to a predetermined threshold, clustering unit 13 may perform clustering such that the maximum cluster includes a number of drones that is greater than or equal to x×r+b (b is a negative constant). In this way, the cluster size of the maximum cluster can be optimized such that a time required to correct the sensors remains within an allowable range.

### Modified Example 4

In a case of correcting sensors for which differences in operation results need to be observed and detected over a predetermined time (e.g., in a case of correcting speed sensors, acceleration sensors, or the like), a state in which drones 10 included in the maximum cluster may change during a predetermined monitoring time. If drones 10 that are included in the maximum cluster frequently change, a size of the maximum cluster may be increased until a change of drones 10 included in the maximum cluster becomes sufficiently small; or weighting may be performed in accordance with a time during which combinations of drones 10 included in the maximum cluster remains unchanged.

To increase the maximum cluster when drones 10 included in the maximum cluster frequently change over time, clustering unit 13 may determine a level of change in dissimilarity (e.g., a ratio of the number of drones that have changed, relative to the cluster size) of drones 10 included in the maximum cluster over a given period. If the level of change exceeds a threshold level, the number of drones 10 included in the maximum cluster may be increased until the level of change is less than or equal to the threshold level. This stabilizes drones 10 included in the maximum cluster, as a result of which the correction accuracy is also improved.

To perform weighting in a case in which drones 10 included in the maximum cluster frequently change over time, clustering unit 13 determines a level of change in dissimilarity of drones 10 included in the maximum cluster over a given period. If the level of change exceeds a threshold level, correction unit 14 performs correction using a weight value in accordance with a period during which a combination of plurality of drones 10 included in the maximum cluster is maintained. The term “weighting” as used herein refers to assigning a weight such that a longer a period during which a combination of a plurality of drones 10 is maintained, the larger the weight is. In this way, accuracy of correction can be maintained even if drones 10 included in the maximum cluster frequently change.

### Modified Example 5

When t is a parameter corresponding to a deviation amount of sensors from a point in time at which the sensors were last calibrated, Xₐₗₗ is a parameter that corresponds to the number of all drones 10, Xₜ is a parameter that corresponds to the number of drones 10 subject to the deviation amount, and rₜ∈[0,1] is a parameter that corresponds to the ratio of drones 10 that have been effectively calibrated at the deviation amount t, and use of the appropriate value of r can be determined by the following expression: r=(ΣₜrₜXₜ)/Xₐₗₗ, where t is “deviation amount” from the final calibration time, and is specifically the number of flight days, number of flight times, flight distance, or the like of drones 10. When a continuous quantity is used for t, t may have a weighted average value obtained by integration. rₜ may be freely defined, but preferably is determined depending on, for example, a type or mechanism of the sensors, the arrangement of the sensors in drones 10, or a flight environment, storage environment, or the like of drones 10. The reason for this is that a likelihood of deviation of detection values differs when different detection methods are deployed even when the detection targets of the sensors are the same. Thus, even when the same sensors are used, it can be anticipated that detection values of speeds are more likely to deviate in an environment, for example, where a wind speed is highly variable. Therefore, rₜ may approach 0 while t is smaller. That is, rₜ is preferably a value that accords to a type or mechanism of the sensors, positions of the sensors in drones 10, or an environment of drones 10.

### Modified Example 6

The relationship between the number of drones 10 included in the maximum cluster and r may differ according to each of the sensors. The reason for this is that a larger maximum cluster may be required depending on a type or mechanism of the sensors.

### Modified Example 7

The block diagram used in the description of the above embodiment is illustrated as having functional unit blocks. These functional blocks (components) are realized by freely combining hardware and/or software. The means for realizing each functional block is not particularly limited. That is, each functional block may be realized by one device that is physically and/or logically coupled, or may be realized by connecting two or more physically and/or logically separated devices in a direct and/or an indirect manner (e.g., a wired and/or wireless manner) and using these devices. In short, the functions illustrated in FIG. 2 may be provided so as to be distributed in a plurality of drones 10, or may be provided in a server device or the like that is different from drones 10.

### Modified Example 8

Drones to which the present invention is applied are not limited to aerial vehicles, and may have any structure or configuration.

### Other Modified Examples

The aspects/embodiments as described herein may be applied to systems using LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-Wide Band), Bluetooth (registered trademark), and other appropriate systems, and/or next generation systems extended based on these systems.

The processing procedures, sequences, flowcharts, and the like of each of the aspects/embodiments described herein may be reordered as long as no inconsistencies arise. For example, the methods described herein present elements of various steps in exemplary orders, but such step are not limited to such ordering. Each of the aspects/embodiments described herein may be used either alone or in combination, or may be switched in accordance with execution thereof. In addition, notification of predetermined information (e.g., notification of “being X”) is need not be explicitly performed, but may be implicitly performed (e.g., without notification of predetermined information).

The information or parameters described herein may be represented as absolute values, or relative values from predetermined values, or may be represented as other corresponding information.

The term “determining” as used herein may be include various operations. For example, “determining” may include judging, calculating, computing, processing, deriving, investigating, looking up (e.g., looking up in a table, database or another data structure), and ascertaining. Also, the term “determining” may include receiving (e.g., receiving information), transmitting (e.g., transmitting information), input, output, and accessing (e.g., accessing data in a memory). Furthermore, the term “determining” may include resolving, selecting, choosing, establishing, comparing, and the like. That is, the term “determining” may be used to mean that an operation has been “determined.”

The present invention may be provided as an information processing method, or may be provided as a program. Such a program may be provided in a form in which the program is recorded on a recording medium such as an optical disk, or may be provided, for example, in a form in which the program is downloaded onto a computer via a network such as the Internet, and is installed so as to be usable.

Software, instructions, and the like may be transmitted and received via a transmission medium. If, for example, software is transmitted from a website, a server or another remote source using wired technology such as a coaxial cable, an optical fiber cable, a twisted pair wire, a digital subscriber line (DSL) or the like and/or wireless technology such as infrared rays, radio and microwaves, the wired technology and/or wireless technology are included in the definition of a transmission medium.

The information, signals, and the like, described herein may be represented using any of various different techniques. For example, data, instructions, commands, information, signals, bits, symbols, chips, and the like, mentioned throughout the above description, may be represented by voltage, current, magnetic waves, magnetic fields or magnetic particles, optical fields or protons, or any combination thereof.

Reference to elements with designations such as “first,” “second” and so on as used herein does not generally limit the quantity or order of these elements. These designations may be used herein for convenience only to distinguish between two or more elements. Reference to first and second elements does not imply that only two elements may be employed, or that a first element must somehow precede a second element. [0055] The term “means” used as a description of the configuration of each of the devices described above may be substituted with terms such as “unit,” “circuit,” “device,” and the like.

In so far as the terms “including,” “comprising” and variations thereof are used within the present specification or claims, such terms are intended to be comprehensive, similarly to the term “provided with.” Furthermore, the term “or” used in the present specification or claims is not necessarily intended to mean exclusively OR.

Throughout this translation of the present disclosure, for example, articles such as “a”, “an”, and “the” are used, any such article may reference a plurality of nouns, unless context indicates otherwise.

In the foregoing, the present invention has been described detail, it will be obvious to those skilled in the art that the present invention is not limited to the embodiment described in the present specification. The present invention can be implemented in modified or altered ways without departing from the spirit and scope of the present invention as defined by the claims. Accordingly, the description of the present invention is provided for illustrative purposes only and is not limitative of the present invention.

### List of Reference Signs

10 . . . Drone,
11 . . . Operation control unit,
12 . . . Detection unit,
13 . . . Clustering unit,
14 . . . Correction unit,
1001 . . . Processor,
1002 . . . Memory,
1003 . . . Storage,
1004 . . . Communication device,
1005 . . . Input device,
1006 . . . Output device,
1007 . . . Sensor group,
1008 . . . Imaging device,
1009 . . . Flight driving mechanism

1. A correction device comprising:
a detection unit configured to detect, when a plurality of aerial vehicles perform an operation by which detection values of sensors included therein match a target value, a difference in an operation result of each of the aerial vehicles;
a clustering unit configured to classify the plurality of aerial vehicles into at least one cluster based on the detected differences; and
a correction unit configured to correct the detection values of the sensors based on the operation results of the aerial vehicles included in a maximum cluster of the classified clusters.

2. The correction device according to claim 1, wherein
the plurality of aerial vehicles is an x number of aerial vehicles, and,
when a ratio of aerial vehicles of the x number of aerial vehicles that satisfy a predetermined calibration condition for the sensors is r (0<r<1),
the clustering unit is configured to perform clustering such that the maximum cluster includes a number of aerial vehicles that is greater than or equal to x×r.

3. The correction device according to claim 2, wherein,
if the r is less than or equal to a threshold,
the clustering unit is configured to perform clustering such that the maximum cluster includes a number of aerial vehicles that is greater than or equal to x×r+a (a is a positive constant).

4. The correction device according to claim 2, wherein,
if the x is greater than or equal to a threshold,
the clustering unit is configured to perform clustering such that the maximum cluster includes a number of aerial vehicles that is greater than or equal to x×r+b (b is a negative constant).

5. The correction device according to claim 1, wherein
the clustering unit is configured to:
determine a level of change in dissimilarity of the aerial vehicles included in the maximum cluster over a given period; and,
if the level of change exceeds a threshold level, increase the number of the aerial vehicles included in the maximum cluster until the level of change is less than or equal to the threshold level.

6. The correction device according to claim 1, wherein
the clustering unit is configured to
determine a level of change in dissimilarity of the aerial vehicles included in the maximum cluster over a given period, and
the correction unit is configured to,
if the level of change exceeds a threshold level, perform the correction using a weight value according to a period during which a combination of the plurality of aerial vehicles included in the maximum cluster is maintained.

7. The correction device according to claim 2, wherein,
when t is a parameter corresponding to a deviation amount of the sensors from a point in time at which the sensors were last calibrated,
Xall is a parameter corresponding to the number of all aerial vehicles,
Xt is a parameter corresponding to the number of aerial vehicles having a deviation amount t, and
rt∈[0,1] is a parameter corresponding to a ratio of aerial vehicles that have been effectively calibrated at the deviation amount t, and
the r is represented by r=(ΣtrtXt)/Xall.

8. The correction device according to claim 7, wherein
the rt is a value according to a type or mechanism of the sensors, positions of the sensors in the aerial vehicles, or an environment of the aerial vehicles.

9. The correction device according to claim 2, wherein
a relationship between the number of aerial vehicles included in the maximum cluster and the r differs according to each of the sensors.
